(19) United States
(12) Patent Application Publication
(10) Pub. No.: US 2026/0128219 A1
(43) Pub. Date: May 7, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Kwang Dong Seong, Suwon-si (KR); Bonggyu Choi, Suwon-si (KR); Dokyeong Lee, Suwon-si (KR); Sunho Yoon, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/173,501

(22) Filed: Apr. 8, 2025

(30) Foreign Application Priority Data
Nov. 4, 2024 (KR) 10-2024-0154377

(51) Int. Cl. H01G 4/008; H01G 4/10

(52) U.S. Cl. CPC H01G 4/008; H01G 4/10

(57) ABSTRACT

A multilayer ceramic capacitor including a capacitor body; and an external electrode disposed on an outer surface of the capacitor body. The capacitor body includes an active region in which the dielectric layers and the internal electrode layers are alternately disposed, and a cover region in which the dielectric layers are disposed on the upper and lower surfaces of the active region in a stacking direction, the external electrode includes an interface layer disposed on a surface of the active region and an external layer covering the interface layer, the interface layer has a bridge structure including a plurality of leg regions, and a span region disposed between the plurality of leg regions, and the leg region of the interface layer is connected to the internal electrode layer and the span region of the interface layer is disposed on a surface of the dielectric layer.

### CROSS-REFERENCE TO RELATED APPLICATION

This application claims priority to and the benefit of Korean Patent Application No. 10-2024-0154377 filed in the Korean Intellectual Property Office on Nov. 4, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the miniaturization and high-capacitance of MLCCs, research is being conducted on miniaturizing the internal electrode and dielectric thickness, and research is actively being conducted to improve the contact between the internal and external electrodes. To improve the connectivity between the internal and external electrodes, a paste for forming the external electrode with small-sized metal particles applied should be used.

However, as the metal particles used become smaller, the cost per particle increases due to the difficulty of synthesis, and the content of other polymers required for dispersion and adhesion of the paste, such as dispersants and binders, relatively increases, which has the side effect of causing this. As the content of other polymers increases, the metal solids content becomes relatively low, which changes the viscosity and rheological properties, affecting the printing characteristics.

### SUMMARY

An embodiment provides a multilayer ceramic capacitor having improved connectivity between internal electrode layers and external electrodes, thereby exhibiting capacitance characteristics and moisture resistance reliability.

Another embodiment provides a method of manufacturing a multilayer ceramic capacitor.

An embodiment provides a multilayer ceramic capacitor including a capacitor body including a plurality of dielectric layers including a first dielectric layer and a second dielectric layer, and a plurality of internal electrode layers stacked with the first dielectric layer interposed therebetween; and an external electrode disposed on an outer surface of the capacitor body, wherein the capacitor body: includes an active region including the first dielectric layer and the internal electrode layers, and a cover region including the second dielectric layer, the second dielectric layer is disposed on a first surface and a second surface of the active region, wherein the first surface opposes the second surface in a stacking direction, the external electrode includes an interface layer disposed on a third surface of the active region, and an external layer covering the interface layer, the interface layer has a bridge structure including a body region, a leg region including a plurality of leg regions connected to a first portion of the body region, and a span region disposed between the plurality of leg regions, the leg region of the interface layer is connected to the internal electrode layers, the span region of the interface layer is disposed on a surface of the first dielectric layer, and a ratio of a number of internal electrode layers connected to the leg region of the interface layer is greater than or equal to about 90% and less than or equal to about 100% based on a total number of internal electrode layers in the active region.

The leg region of the interface layer may extend into an interior of the capacitor body and be connected to the internal electrode layers.

The leg region of the interface layer may include an alloy that may include a conductive metal.

The leg region of the interface layer may include a Cu-Ni alloy.

The leg region of the interface layer may include the alloy in an amount of about 60 volume% to about 100 volume% based on a total amount of the leg region.

The span region of the interface layer may include glass.

The glass may include at least one selected from aluminum oxide (Al₂O₃) and silicon dioxide (SiO₂).

The span region of the interface layer may include the glass in an amount of about 60 volume % to about 100 volume % based on a total amount of the span region.

The body region of the interface layer may include a conductive metal.

The body region of the interface layer may include copper (Cu).

The body region of the interface layer may include the conductive metal in an amount of about 60 volume % to about 100 volume % based on a total amount of the body region.

The leg region of the interface layer may include an alloy that includes a conductive metal, the span region of the interface layer may include glass, and the body region of the interface layer may include the conductive metal.

The leg region of the interface layer may include a Cu-Ni alloy, the span region of the interface layer may include glass, and the body region of the interface layer may include copper (Cu).

The internal electrode layer may include an alloy at an interface with the interface layer, and the alloy includes a conductive metal.

Another embodiment provides a multilayer ceramic capacitor including a capacitor body including a plurality of dielectric layers including a first dielectric layer and a second dielectric layer, and a plurality of internal electrode layers stacked with the first dielectric layer interposed therebetween; and an external electrode disposed on an outer surface of the capacitor body, wherein the capacitor body: includes an active region including the first dielectric layer and the internal electrode layers, and a cover region including the second dielectric layer, the second dielectric layer is disposed on a first surface and a second surface of the active region, wherein the first surface opposes the second surface in a stacking direction, the external electrode includes an interface layer disposed on a third surface of the active region, and an external layer covering the interface layer, the interface layer has a bridge structure including a body region, a leg region including a plurality of leg regions connected to a first portion of the body region, and a span region disposed between the plurality of leg regions, the leg region of the interface layer is connected to the internal electrode layers, the span region of the interface layer is disposed on a surface of the first dielectric layer, and the body region of the interface layer includes a conductive metal, the leg region of the interface layer includes an alloy that includes a conductive metal, and the span region of the interface layer includes glass.

The conductive metal may include copper (Cu), the alloy may include a Cu-Ni alloy, and the glass may include aluminum oxide (Al₂O₃) and silicon dioxide (SiO₂).

Another embodiment provides a method of manufacturing a multilayer ceramic capacitor which includes: forming an external electrode on a surface of a capacitor body that includes a plurality of dielectric layers including a first dielectric layer, and a plurality of internal electrode layers stacked with the first dielectric layer interposed therebetween, wherein the external electrode includes an interface layer, and an external layer covering the interface layer, the forming of the external electrode including: applying a metal-organic decomposition (MOD) ink to the surface of the capacitor body, reducing the applied metal-organic decomposition (MOD) ink to form a metal particle film; applying a paste including a conductive metal and a glass composition on the metal particle film; and firing the metal particle film and the applied paste to form the interface layer and the external layer, respectively, wherein the interface layer has a bridge structure including a body region, a leg region including a plurality of leg regions connected to a first portion of the body region, and a span region disposed between the plurality of leg regions, the leg region of the interface layer is connected to the internal electrode layers, and the span region of the interface layer is disposed on a surface of the first dielectric layer.

The metal-organic decomposition (MOD) ink may include a metal ligand material, an amine compound, a binder, an antioxidant, and a solvent.

The metal particle film may include metal nanoparticles having a size of about 10 nm to about 100 nm.

The paste may include the glass composition in an amount of about 20 wt % to about 40 wt % based on a total amount of the paste.

Another embodiment provides a method of manufacturing a multilayer ceramic capacitor which includes: forming an external electrode on a surface of a capacitor body that includes a plurality of dielectric layers including a first dielectric layer, and a plurality of internal electrode layers stacked with the first dielectric layer interposed therebetween, wherein the external electrode includes an interface layer, and an external layer covering the interface layer, the forming of the external electrode including: applying a metal ligand material to the surface of the capacitor body, reducing the applied metal ligand material to form a film that includes nanoparticles; applying a paste including a conductive metal and a glass composition on the film; and firing the film and the applied paste to form the interface layer and the external layer, respectively, wherein the interface layer includes glass.

The interface layer has a bridge structure including a body region, a leg region including a plurality of leg regions connected to a first portion of the body region, and a span region disposed between the plurality of leg regions, the leg region of the interface layer extends from the internal electrode layers to the first portion of the body region, and the span region of the interface layer is disposed on a surface of the first dielectric layer.

The reducing of the applied metal ligand material may be carried out in a nitrogen atmosphere at a temperature of 170° C. to 300° C. for 30 minutes to 3 hours.

The metal ligand material may include copper formate.

A multilayer ceramic capacitor according to an embodiment can have excellent capacitance characteristics and moisture resistance reliability as the connectivity between the internal electrode layers and the external electrodes is improved.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure in the capacitor body of FIG. 1.

FIG. 5A is a schematic view showing an external electrode of a multilayer ceramic capacitor according to an embodiment.

FIG. 5B is an enlarged view of the R region in FIG. 5A.

FIG. 6 is a schematic view showing a method for manufacturing an external electrode of a multilayer ceramic capacitor according to an embodiment.

FIGS. 7A to 7C are scanning electron microscope (SEM) analysis images of the external electrode of the multilayer ceramic capacitor according to Example 1. FIG. 7B is an expanded view of the boxed regions indicated in FIG. 7A. FIG. 7C is an expanded view of the boxed regions indicated in FIG. 7B.

FIGS. 8A to 8C are scanning electron microscope (SEM) analysis images of the external electrode of the multilayer ceramic capacitor according to Comparative Example 1. FIG. 8B is an expanded view of the boxed regions indicated in FIG. 8A. FIG. 8C is an expanded view of the boxed regions indicated in FIG. 8B.

FIGS. 9A and 9B are scanning electron microscope-energy dispersive spectroscopy (SEM-EDS) mapping analysis images of the external electrode of the multilayer ceramic capacitor according to Example 1.

FIGS. 10A and 10B are scanning electron microscope-energy dispersive spectroscopy (SEM-EDS) mapping analysis images of the external electrode of the multilayer ceramic capacitor according to Comparative Example 1.

FIG. 11 is a graph showing the capacitance characteristics of the multilayer ceramic capacitor according to Example 1 and Comparative Example 1.

FIG. 12 is a graph showing the moisture resistance reliability of the multilayer ceramic capacitor according to Example 1.

FIG. 13 is a graph showing the moisture resistance reliability of the multilayer ceramic capacitor according to Comparative Example 1.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be disposed above or below the reference element, and it is not necessarily referred to as being disposed “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Additionally, throughout the specification, when it is said to ‘include as a main component’, it means that among at least one component present in an area, one component has the highest content based on a total amount of components.

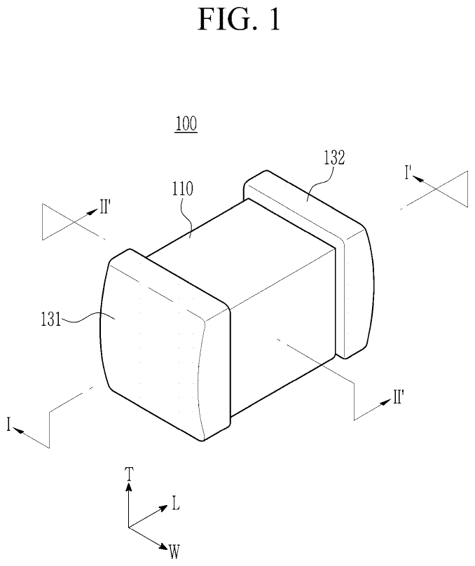

Hereinafter, a multilayer ceramic capacitor according to an embodiment will be described with reference to FIGS. 1 to 4.

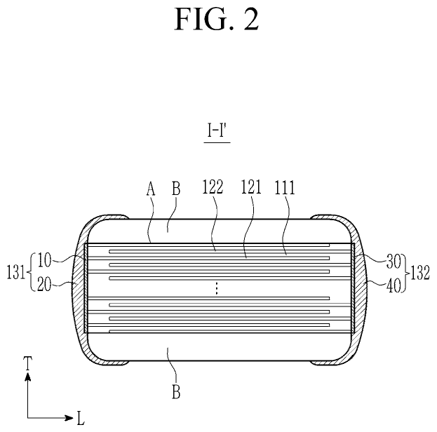

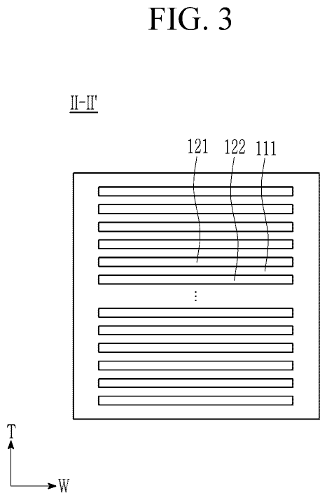

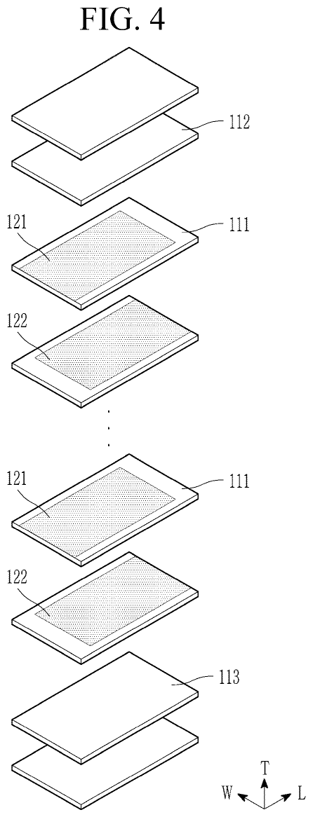

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be, for example, used as the same concept as a stacking direction in which a dielectric layer 111 are stacked. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are disposed. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be disposed on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be disposed on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the internal electrode layers 121 and 122 due to physical or chemical stress.

Detailed descriptions of the dielectric layer 111 and the internal electrode layers 121 and 122 will be provided later.

### External Electrode

The external electrodes 131 and 132 according to an embodiment, the external electrodes 131 and 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

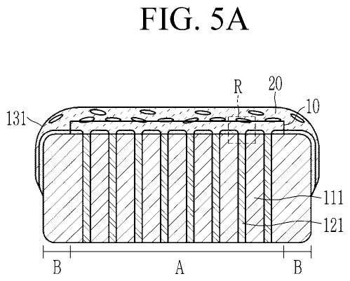

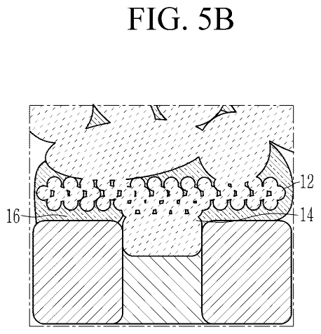

FIG. 5A is a schematic view showing an external electrode of a multilayer ceramic capacitor according to an embodiment and FIG. 5B is an enlarged view of the R region in FIG. 5A.

Referring to FIGS. 5A and 5B, external electrodes 131 and 132 according to an embodiment includes interface layers 10 and 30 disposed on one surface of an active region A of a capacitor body 110 and external layers 20 and 40 covering the interface layers 10 and 30. The interface layers 10 and 30 are disposed in connection with the internal electrode layers 121 and 122. Specifically, the first external electrode 131 includes a first interface layer 10 connected to the first internal electrode layer 121 and a first external layer 20 covering the first interface layer 10. Additionally, the second external electrode 132 includes a second interface layer 30 connected to the second internal electrode layer 122 and a second external layer 40 covering the second interface layer 30.

For example, the interface layers 10 and 30 may be defined as a region from an interface between the external electrodes 131 and 132 and the internal electrode layers 121 and 122 to a depth of about 1 μm to about 5 μm from the interface, for example, about 2 μm to about 4 μm from the interface, in the vertical direction of the stacking direction, i.e., in the length (L-axis) direction of the multilayer ceramic capacitor, toward the external electrodes.

The interface layers 10 and 30, that is, the first interface layer 10 and the second interface layer 30, may have a bridge structure including a body region 12, a plurality of leg regions 14 connected to a lower portion of the body region 12, and span regions 16 disposed between the plurality of leg regions 14.

Herein, the leg region 14 may be connected to the internal electrode layers 121 and 122 and specifically, extended into the inside of the capacitor body 110 to be connected to the internal electrode layers 121 and 122. In addition, the span regions 16 may be disposed on a surface of the dielectric layer 111.

For example, the body region 12 may be a region covering from an interface between the interface layers 10 and 30 and the external layers 20 and 40 toward the interface layers 10 and 30 to a depth of about 5% to about 15% of a thickness of the interface layers 10 and 30. In addition, the leg region 14 may be within a region from an interface between the external electrodes 131 and 132 and the internal electrode layers 121 and 122 toward the external electrodes 131 and 132 to a depth of about 85% to about 95% of the thickness of the interface layers 10 and 30. In addition, the span region 16 may be within a region from an interface between the external electrodes 131 and 132 and the dielectric layer 111 toward the external electrodes 131 and 132 to a depth of about 85% to about 95% of the thickness of the interface layers 10 and 30.

The external electrode, which includes the interface layer with the bridge structure, may improve a contact with the internal electrode layer and form a hermetic sealing structure, which is a completely sealed structure that prevents external moisture from entering. Accordingly, a multilayer ceramic capacitor with excellent capacitance characteristics and moisture resistance reliability may be secured.

According to an embodiment, the leg region 14 of the interface layers 10 and 30 are connected with the internal electrode layers 121 and 122, and specifically, the number of the internal electrode layers 121 and 122 connected with the leg region 14 of the interface layers 10 and 30 may have a ratio of greater than or equal to about 90% and less than or equal to about 100%, for example, about 93% to 100%, or about 95% to 100% based on a total number of the internal electrode layers 121 and 122 in the active region A. When the internal electrode layer and the leg region of the interface layer are connected within the ratio ranges, as the contact between the external electrode and the internal electrode layer is increased, the internal electrode layer and the leg region of the interface layer may form the hermetic sealing structure, which is a completely close and seal structure that completely blocks external moisture from entering. The interface layers 10 and 30 with the bridge structure may include a conductive metal and glass.

The interface layers 10 and 30 of the external electrodes 131 and 132 according to an embodiment may be formed by applying a metal-organic decomposition (MOD) ink including a metal ligand material on a surface of the capacitor body 110.

In general, if Cu particles with a small size are applied to a past for forming an external electrode to improve contact properties, a specific surface area of the particles becomes very large, which causes a problem of increasing a content of a dispersant. In addition, when the fine particles are increased, the increased specific surface area may cause a friction, which leads to significantly increase static viscosity of the paste and resultantly, cause many problems in forming external electrodes in a conventional dipping method. In addition, the fine Cu particles are not readily available and expensive to produce, making them uneconomical.

In an embodiment, as the interface layers 10 and 30 of the external electrodes 131 and 132 are formed by applying the MOD ink, because metals such as Cu and the like form complexes with organic materials and exist as ions, there are advantages of no problem with dispersibility, very low static viscosity, and inexpensive raw materials. The organic materials may be removed by adopting a simple reduction process to obtain fine Cu particles with a very small size of less than or equal to about 100 nm, such fine Cu particles may be used to improve contact properties between internal electrode layer and external electrode.

The conductive metal included in the interface layers 10 and 30 may include at least one metal selected from copper (Cu), nickel (Ni), silver (Ag), palladium (Pd), gold (Au), platinum (Pt), tin (Sn), tungsten (W), titanium (Ti), and lead (Pb). In addition, the interface layers 10 and 30 may further include an alloy of the conductive metal.

Specifically, the body region 12 of the interface layers 10 and 30 may include the conductive metal such as Cu and the like, the leg region 14 of the interface layers 10 and 30 may include the alloy of the conductive metal such as Cu-Ni and the like, and the span region 16 of the interface layers 10 and 30 may include glass.

The external electrodes 131 and 132 including the interface layers 10 and 30 and the external layers 20 and 40 may be formed by applying a MOD ink including a metal ligand material on a surface of the capacitor body 110 to form a metal particle film, applying a paste including a conductive metal and a glass composition on the metal particle film, and then, firing them.

Herein, during the firing, as the materials are sintered on the interface due to metal particles such as Cu with a small size and the like constituting the metal particle film, an alloy between the metal particles such as Cu and the like and metals such as Ni and the like of the internal electrode layer may be first formed, and then, the glass composition of the paste may be penetrated. Accordingly, the internal electrode layer and the external electrode are firmly connected to each other due to the formation of the alloy such as Cu-Ni and the like on the interface of the internal electrode layer and the external electrode, and glass components of the glass composition may be penetrated into a surface of the dielectric layer during the firing, forming an interface layer with a bridge structure. The external electrode with the interface layer with the bridge structure may not only improve connectivity with the internal electrode layer but also have the hermetic sealing structure, which is a complete close and seal structure completely blocking external moisture, due to the glass on a surface of the dielectric layer.

Hereinafter, each region is illustrated in more detail.

The body region 12 of the interface layers 10 and 30 may include the conductive metal, for example, copper (Cu). In addition, the body region 12 may further include a Cu-Ni alloy.

The conductive metal included in the body region 12 may be derived from the metal ligand material of the MOD ink and as formed from the MOD ink, may be fine metal particles of about 100 nm or less.

The body region 12 may include the conductive metal as a primary component. Specifically, the body region 12 may include copper (Cu) in an amount of about 60 volume % to about 100 volume % based on based on a total amount of the body region 12, for example, about 65 volume % to about 95 volume % or about 70 volume % to about 90 volume %. If the conductive metal is included within the content ranges in the body region 12, connectivity between external electrode and internal electrode layer may be improved. The content of the conductive metal in the body region 12 may be determined by scanning electron microscope-energy dispersive spectroscopy (SEM-EDS). Other methods and/or tools appreciated by one of ordinary skill in the art, even if not described in the present disclosure, may also be used.

The body region 12 may further include glass.

The leg region 14 of the interface layers 10 and 30, which is connected to the internal electrode layers 121 and 122 and specifically, extended into the inside of the internal electrode layers 121 and 122 to be connected thereto, may include an alloy of a conductive metal.

The alloy of the conductive metal may be an alloy formed of two or more metals selected from the conductive metals, that is, from copper (Cu), nickel (Ni), silver (Ag), palladium (Pd), gold (Au), platinum (Pt), tin (Sn), tungsten (W), titanium (Ti), and lead (Pb), for example, a Cu-Ni alloy.

The alloy of the conductive metals such as Cu-Ni and the like included in the leg region 14 may be formed as an alloy of the metals such as Cu and the like derived from the metal ligand material of the MOD ink with metals such as Ni and the like, a primary component of the internal electrode layer. If the alloy is formed in the leg region 14, the internal electrode layer and the external electrode may be firmly connected.

The leg region 14 may include the alloy of the conductive metal as a primary component. Specifically, the leg region 14 may include the alloy of the conductive metal in an amount of about 60 volume % to about 100 volume % based on a total amount of the leg region 14, for example, about 65 volume % to about 95 volume %, or about 70 volume % to about 90 volume %. If the alloy of the conductive metal is included within the content ranges in the leg region 14, connectivity of the internal electrode layer and the external electrode may be significantly improved. The content of the alloy in the leg region 14 may be determined by scanning electron microscope-energy dispersive spectroscopy (SEM-EDS) and/or calculated from the amounts of the metals constituting the alloy determined by scanning electron microscope-energy dispersive spectroscopy (SEM-EDS). Other methods and/or tools appreciated by one of ordinary skill in the art, even if not described in the present disclosure, may also be used.

The leg region 14 may further include at least one selected from the conductive metal and glass.

The span region 16 of the interface layers 10 and 30 may include glass. In the interface layers 10 and 30, if the glass is included in the span region 16 disposed between the plurality of leg regions 14 and disposed a surface of the dielectric layer 111, the external electrodes 131 and 132 according to an embodiment may have the hermetic sealing structure, a complete close and seal structure that prevents external moisture from entering.

The glass included in the span region 16 may be derived from the glass composition of the paste applied on the formed metal particle film.

The glass may include glass with corrosion resistance. Specifically, the glass may include at least one selected from aluminum oxide (Al₂O₃) and silicon dioxide (SiO₂). For example, the glass may include aluminum oxide (Al₂O₃) and silicon dioxide (SiO₂). If the span region 16 of the interface layers 10 and 30 includes the glass, moisture resistance reliability may be greatly improved.

The span region 16 may include the glass as a primary component. Specifically, the span region 16 may include the glass in an amount of about 60 volume % to about 100 volume % based on a total amount of the span region 16, for example, about 65 volume % to about 95 volume % or about 70 volume % to about 90 volume %. If the glass is included within the content ranges in the span region 16, moisture resistance reliability may be greatly improved. The content of the glass in the span region 16 may be calculated from the amount of elements constituting glass (e.g., Si, Al, Li, Na, Zn, Ba, and/or Ca) measured with scanning electron microscope-energy dispersive spectroscopy (SEM-EDS). Other methods and/or tools appreciated by one of ordinary skill in the art, even if not described in the present disclosure, may also be used.

The span region 16 may further include at least one selected from the conductive metal and the alloy of the conductive metal.

For example, the body region 12 of the interface layers 10 and 30 may include copper (Cu), the leg region 14 of the interface layers 10 and 30 may include a Cu-Ni alloy, and the span region 16 of the interface layers 10 and 30 may include glass, for example, glass including aluminum oxide (Al₂O₃) and silicon dioxide (SiO₂).

In the interface layers 10 and 30 having a bridge structure and disposed on the interface between the active region A of the capacitor body 110 and the external electrodes 131 and 132, because the Cu-Ni alloy is included in the leg region 14 connected to the internal electrode layers 121 and 122, the glass is included in the span region 16 disposed on a surface of the dielectric layer 111, and Cu is included in the body region 12 contacting with the external layers 20 and 40, the external electrode and the internal electrode layer may not only maintain firm connectivity but also have a completely close and seal structure completely preventing external moisture from entering, thereby securing a multilayer ceramic capacitor with excellent capacitance characteristics and moisture resistance reliability.

The external layers 20 and 40 covering the interface layers 10 and 30 may include a conductive metal and glass. Types of the conductive metal and the glass are respectively the same as described above and will not be repetitively illustrated.

The external electrodes 131 and 132 according to an embodiment are measured with respect to structures, components, and contents through scanning electron microscope (SEM) and scanning electron microscope-energy dispersive spectroscopy (SEM-EDS) analysis.

Specifically, a multilayer ceramic capacitor 100 is loaded onto a tape with the L-axis and T-axis direction surfaces (LT surfaces) facing upward, placed in an epoxy mixing solution, and cured. Then, the LT surface of the capacitor body 110 is polished to ½ of the point in the W-axis direction, thereby obtaining a cross-sectional sample having an LT surface so that the external electrode can be observed. Subsequently, the cross-sectional sample is taken a scanning electron microscope (SEM) image of so that the capacitor body and the external electrode in one side of the cross-sectional sample are visible to check an interface layer of the external electrode and in addition, check whether the interface layer has a bridge structure having a body region, leg regions, and a span region. For example, SEM may measure at an accelerating voltage of about 20 kV and a magnification of about 10k.

In addition, in the SEM image of the obtained cross-sectional sample, a ratio of the number of the internal electrode layers connected to the leg region of the interface layer based on the total number of the internal electrode layers in the active region may be checked. Other methods and/or tools appreciated by one of ordinary skill in the art, even if not described in the present disclosure, may also be used.

In addition, the SEM image of the obtained cross-sectional sample is subjected to energy dispersive spectroscopy (EDS) analysis to check components and contents of the interface layer with the bridge structure.

The external layers 20 and 40 may include about 60 wt % to about 80 wt % of the conductive metal and about 20 wt % to about 40 wt % of the glass, for example, about 65 wt % to about 75 wt % of the conductive metal and about 25 wt % to about 35 wt % of the glass. If the external layer has the compositions, a multilayer ceramic capacitor with excellent capacitance characteristics and moisture resistance reliability may be obtained.

The external electrodes 131 and 132 may further include a conductive resin layer disposed on the external layers 20 and 40 to cover the aforementioned external layers 20 and 40, and a plating layer disposed to cover the conductive resin layer.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the external layers 20 and 40 are extended and disposed to the first and second surfaces or the fifth and sixth surfaces of the capacitor body 110. That is, the conductive resin layer may be formed on the external layers 20 and 40, and may be formed in the shape that completely covers the sintered metal layer.

The conductive resin layer may include a resin and a conductive metal. The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the interface layers 10 and 30 and external layers 20 and 40.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outer surface the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outer surface, heat resistance, and equivalent series resistance (ESR) of the multilayer ceramic capacitor 100.

### Dielectric Layer and Internal Electrode Layer

According to an embodiment, the dielectric layer 111 may include a barium titanate-based compound including barium (Ba) and titanium (Ti) as a main component. The barium titanate-based compound is a dielectric base material, has a high dielectric constant, and contributes to forming the dielectric constant of a multilayer ceramic capacitor 100. For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

The dielectric layer 111 may further include subcomponent. The subcomponent may include one or more selected from, for example, manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 0.1 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 can be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers. In a scanning electron microscope (SEM) image of a measured cross-sectional sample, a central point in the length direction (L-axis direction) or width direction (W-axis direction) of the dielectric layer 111 is used as a reference point, and an arithmetic mean value of the thickness of the dielectric layer 111 at 10 points spaced at a predetermined interval from the reference point can be obtained. The intervals of the 10 points may be adjusted depending on the scale of the SEM image, and may be, for example, about 1 μm to about 100 μm, about 1 μm to about 50 μm, or about 1 μm to about 10 μm. At this time, all 10 points should be disposed within the dielectric layer 111, and if all 10 points are not disposed within the dielectric layer 111, the position of the reference point may be changed, or the interval between the 10 points may be adjusted.

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 includes a conductive metal, and may include, for example, at least one metal selected from Ni, Cu, Ag, Pd, Au, or an alloy thereof.

The internal electrode layers 121 and 122 may be connected to the interface layers 10 and 30 of the external electrodes 131 and 132, and specifically, can be connected to the leg region 14 of the interface layers 10 and 30 having a bridge structure.

Specifically, the internal electrode layers 121 and 122 may include an alloy such as Cu-Ni at an interface with the interface layers 10 and 30 of the external electrodes 131 and 132.

Additionally, the internal electrode layers 121 and 122 may include dielectric particles having the same composition as the ceramic material included in the dielectric layer 111.

The internal electrode layers 121 and 122 may be formed using a conductive paste including a conductive metal. The printing method for the conductive paste may be either screen printing or gravure printing.

An average thickness of the internal electrode layers 121 and 122 may be about 0.1 μm to about 2 μm. When the average thickness of the internal electrode layers 121 and 122 is within the above range, the reliability of the multilayer ceramic capacitor is improved.

The average thickness of the internal electrode layers 121 and 122 can be measured by scanning electron microscope (SEM) analysis. Specifically, in a scanning electron microscope (SEM) image of a cross-sectional sample measured as described above, a central point in the length direction (L-axis direction) or width direction (W-axis direction) of the internal electrode layers 121 and 122 is used as a reference point, and an arithmetic mean value of the thickness of the internal electrode layers 121 and 122 at 10 points spaced at a predetermined interval from the reference point can be obtained. The intervals between the 10 points may be adjusted according to the scale of the scanning electron microscope (SEM) image, and may be, for example, about 1 μm to about 100 μm, about 1 μm to about 50 μm, or about 1 μm to about 10 μm. At this time, all 10 points should be disposed within the internal electrode layers 121 and 122, and if all 10 points are not disposed within the internal electrode layers 121 and 122, the position of the reference point may be changed or the interval between the 10 points may be adjusted.

The capacitor body 110 may be formed by firing a stacking structure in which the plurality of dielectric layers 111 and internal electrode layers 121 and 122 are stacked.

Hereinafter, a method of manufacturing the multilayer ceramic capacitor 100 according to an embodiment will be described.

### Method of Manufacturing Multilayer Ceramic Capacitor

The multilayer ceramic capacitor 100 according to an embodiment may be manufactured by applying and reducing a metal-organic decomposition (MOD) ink to a surface of a capacitor body 110 to form a metal particle film; applying a paste including a conductive metal and a glass composition to a surface of the capacitor body on which the metal particle film is formed; and firing the paste to form an external electrodes 131 and 132 including interface layers 10 and 30 formed from the metal particle film and external layers 20 and 40 formed from the paste and covering the interface layers.

Hereinafter, a method of manufacturing the capacitor body 110 will be described.

The capacitor body 110 may be manufactured by manufacturing a dielectric green sheet using the dielectric slurry and forming a conductive paste layer on the surface of the dielectric green sheet; manufacturing a dielectric green sheet stack by stacking the dielectric green sheet on which the conductive paste layer is formed; and firing the dielectric green sheet stack.

The dielectric slurry may be prepared by mixing a barium titanate-based main component powder and, optionally, a subcomponent powder.

Since the barium titanate-based main component powder is the same as the barium titanate-based main component included in the dielectric layer, its description is omitted here.

The subcomponent powder may include manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), or a combination thereof, but is not limited thereto. Each of the subcomponent powder may be included in an amount of about 0.01 parts by mole to about 5 parts by mole based on 100 parts by mole of the barium titanate-based main component powder.

The subcomponent powder may be used in a form of an oxide or salt compound including each metal, or may be used in a form of a sol dispersed in an organic solvent.

In addition, the dielectric slurry may be prepared by additionally mixing additives such as a dispersant, a binder, a plasticizer, a lubricant, an antistatic agent, and a solvent.

The barium titanate-based main component powder and optionally the subcomponent powder may be mixed using a wet ball mill or a stirring mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing. As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes an internal electrode layer after firing, a conductive paste may be prepared by mixing a conductive powder made of a conductive metal or an alloy thereof, a binder, and a solvent. Additionally, a barium titanate powder may be mixed in as a co-material if necessary. The co-material may act to suppress sintering of the conductive powder during the firing process. In the step of manufacturing the dielectric green sheet, a dielectric slurry may be prepared by mixing a barium titanate-based compound as a main component powder and optionally a subcomponent powder. The conductive powder may include nickel (Ni) or a nickel (Ni) alloy.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body is manufactured after binder removal treatment and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen. When the internal electrode includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode and the second internal electrode may be exposed to the outermost surfaces of the third and fourth surfaces, and thus the electrical connection between the first external electrode and the second external electrode, and the first internal electrode and the second internal electrode may be improved, alloy portions may be easily formed.

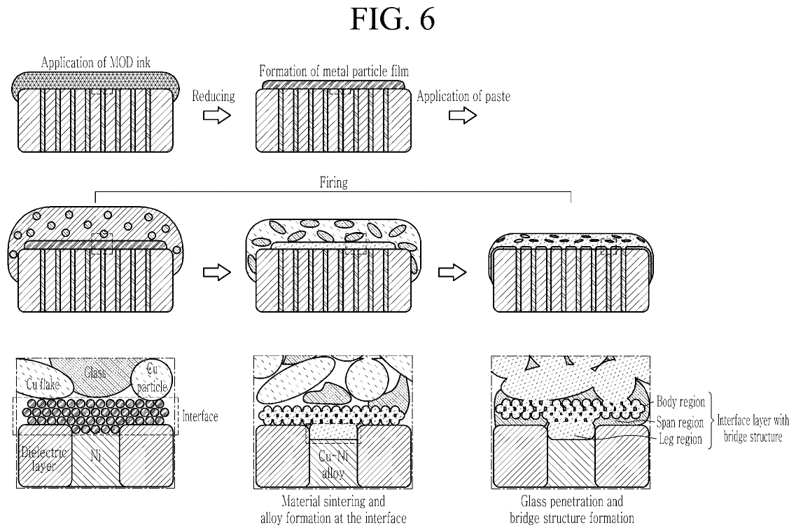

Next, a method for manufacturing the external electrodes 131 and 132 will be described with reference to FIG. 6.

FIG. 6 is a schematic view showing a method for manufacturing an external electrode of a multilayer ceramic capacitor according to an embodiment. Referring to FIG. 6, a metal-organic decomposition (MOD) ink is applied and reduced on a surface of the above-mentioned manufactured capacitor body 110 to form a metal particle film.

The metal-organic decomposition (MOD) ink is applied to at least the third surface and the fourth surface of the capacitor body 110, and optionally also to a portion of the first surface, the second surface, the fifth surface, or the sixth surface on which the band portions of the first external electrode and the second external electrode are formed.

The metal-organic decomposition (MOD) inks may include a metal ligand material, an amine compound, a binder, an antioxidant, and a solvent.

The metal ligand material may include a conductive metal formate formed by reacting a conductive metal precursor with formic acid.

The conductive metal precursor may be a precursor including a conductive metal including at least one metal selected from copper (Cu), nickel (Ni), silver (Ag), palladium (Pd), gold (Au), platinum (Pt), tin (Sn), tungsten (W), titanium (Ti), and lead (Pb); an alloy thereof; or a combination thereof. Examples of such a conductive metal precursor may include metal oxide, metal hydroxide, metal nitrate, metal carbonate, metal sulfate, metal chloride, metal acetate, or a combination thereof.

The metal ligand material may be included in an amount of about 20 wt % to about 40 wt % based on a total amount of the metal-organic decomposition (MOD) ink.

Examples of the amine compound may include butylamine, hexylamine, octylamine, dibutylamine, triethylamine, diethylenetriamine, ethylenediamine, cyclohexylamine, aminomethylpropanol, 2-amino-2-methyl-1-propanol (AMP), or a combination thereof.

The amine compound may be included in an amount of about 20 wt % to about 60 wt % based on a total amount of the metal-organic decomposition (MOD) ink.

The binder may include a thermoplastic resin, a thermosetting resin, a natural polymer, or a combination thereof. Examples of the thermoplastic resin may include an acrylic resin, a cellulose resin, an aliphatic or copolymerized polyester resin, a vinyl resin, a polyamide resin, a polyurethane resin, a polyether resin, a urea resin, an alkyd resin, a silicone resin, a fluorine resin, an olefin resin, etc. The acrylic resin may be, for example, polyacrylic acid, polyacrylic acid ester, etc. Examples of the thermosetting resin may include an epoxy resin, an unsaturated or vinyl polyester resin, a diallyl phthalate resin, a phenol resin, an oxetane resin, an oxazine resin, a bismaleimide resin, a modified silicone resin, a melamine resin, etc. Examples of the natural polymer may include an ethylene-propylene rubber (EPR), a styrene-butadiene rubber (SBR), starch, gelatin, etc.

The binder may be included in an amount of about 0.1 wt % to about 5 wt % based on a total weight of the metal-organic decomposition (MOD) ink.

The antioxidant may include organic acid such as oleic acid.

The antioxidant may be included in an amount of about 0.1 wt % to about 5 wt % based on a total weight of the metal-organic decomposition (MOD) ink.

The solvent may include water; an alcohol solvent such as methanol, ethanol, isopropanol, 1-methoxypropanol, butanol, ethylhexyl alcohol, and terpineol; glycol solvents such as ethylene glycol and glycerin; acetate solvents such as ethyl acetate, butyl acetate, methoxypropyl acetate, carbitol acetate, and ethyl carbitol acetate; ether solvents such as methyl cellosolve, butyl cellosolve, diethyl ether, tetrahydrofuran, and dioxane; a ketone solvent such as methyl ethyl ketone, acetone, dimethylformamide, and 1-methyl-2-pyrrolidone; a hydrocarbon solvent such as hexane, heptane, dodecane, paraffin oil, and mineral spirit; an aromatic solvent such as benzene, toluene, and xylene; a halogen-substituted solvent such as chloroform, methylene chloride, and carbon tetrachloride. or a combination thereof.

The solvent may be included as a balance amount based on a total amount of the metal-organic decomposition (MOD) ink.

The metal-organic decomposition (MOD) ink may be applied with a thickness of about 50 μm to about 400 μm, for example, with a thickness of about 80 μm to about 350 μm. When the metal-organic decomposition (MOD) ink is applied within the above thickness range, an interface layer formed after firing can be formed with an appropriate thickness, thereby enhancing the contact between the internal electrode layer and the external electrode.

The reducing may be carried out in a nitrogen atmosphere, at a temperature of about 170° C. to about 300° C., for example, at a temperature of about 180° C. to about 250° C., for about 30 minutes to about 3 hours, for example, for about 40 minutes to about 2 hours. When reduced under conditions within the above range, the contact between the internal electrode layers and the external electrode can be strengthened due to the formation of the interface layer.

When the metal-organic decomposition (MOD) ink is applied to a surface of a capacitor body 110 and reduced, a metal particle film including very small and uniform metal nanoparticles can be formed. For example, the metal particle film may include metal nanoparticles having a size of about 10 nm to about 100 nm, for example, metal nanoparticles having a size of about 15 nm to about 90 nm. The size of the metal nanoparticles may be determined by scanning electron microscope (SEM). Other methods and/or tools appreciated by one of ordinary skill in the art, even if not described in the present disclosure, may also be used. Subsequently, the paste is applied to a surface of the capacitor body 110 on which a metal particle film is formed, and then fired.

The paste includes a conductive metal and glass composition.

The glass composition may be included in an amount of about 20 wt % to about 40 wt %, for example, about 22 wt % to about 38 wt %, or about 24 wt % to about 36 wt % based on a total amount of the paste.

Since the descriptions of the conductive metal and glass composition are the same as that of the conductive metal and glass described above, the descriptions thereof are omitted here.

The paste may further include a binder, a solvent, a dispersant, a plasticizer, an oxide powder, etc.

The binder may be, for example, ethyl cellulose, acrylic, butyral, etc., and the solvent may be, for example, an organic solvent or aqueous solvent such as terpineol, butyl carbitol, alcohol, methyl ethyl ketone, acetone, toluene, and the like.

Methods for applying the paste on the a surface of the capacitor body 110 may include various printing methods such as dip method and screen printing, application method using a dispenser, etc., and spraying method using spray. The paste may be applied to at least the third and fourth surfaces of the capacitor body 110, and optionally applied to a portion of the first, second, fifth, or the sixth surfaces on which the band portions of the first and second external electrodes are formed.

The firing may be carried out under a reduction atmosphere having a wetter temperature of about 0° C. to about 40° C. for about 0.5 hours to about 3 hours, for example, about 1 hour to about 2 hours at about 600° C. to about 800° C., for example, about 650° C. to about 750° C.

During the firing, as shown in FIG. 6, materials on the interface with the internal electrode layer may be first sintered to form an alloy such as Cu-Ni and the like due to the fine metal nanoparticles constituting the metal particle film, and then, the glass may be penetrated. The formation of the alloy on the interface firmly maintains connectivity of the internal electrode layer and the external electrode, and the glass may be penetrated into a surface of the dielectric layer, forming an interface layer of the external electrode with a bridge structure. Accordingly, the internal electrode layer and the external electrode may be firmly connected due to the interface layer with the bridge structure, and the glass, specifically, corrosion-resistant glass may be present on a surface of the dielectric layer, forming a complete close and seal structure completely blocking external moisture from entering.

Optionally, a paste for forming the conductive resin layer is applied on an outer surface of the capacitor body 110 in which the external layers 20 and 40 are formed on the interface layers 10 and 30 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethyl cellulose, acrylic, butyral, etc., and the solvent may be an organic solvent or aqueous solvent such as terpineol, butyl carbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer may be formed on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### Manufacturing of Multilayer Ceramic Capacitors

### Example 1

A dielectric green sheet was manufactured using BaTiO₃ powders, a conductive paste layer including Ni was printed on the surface of the dielectric green sheet, and the dielectric green sheets on which the conductive paste layers were formed were stacked and pressed to manufacture a dielectric green sheet stack. A capacitor body was manufactured by calcinating the dielectric green sheet stack at a temperature of 400° C. or less in a nitrogen atmosphere, and then firing under the conditions of a firing temperature of less than or equal to 1300° C. and a hydrogen concentration of less than or equal to 1.0% H₂.

A metal-organic decomposition (MOD) ink including 30 wt % of copper formate (Cu formate), 25 wt % of octylamine, 25 wt % of 2-amino-2-methyl-1-propanol (AMP), 0.5 wt % of oleic acid, 0.5 wt % of acrylic resin (SPB 80), and a balance amount of dihydroterpineol (DHT) was applied to a surface of a capacitor body to a thickness of 100 μm, and reduced at 200° C. for 1 hour under a nitrogen atmosphere to form a Cu particle film composed of Cu nanoparticles with an average size of less than or equal to 100 nm.

On a surface of the capacitor body on which the Cu particle film was formed, a paste including 70 wt % of Cu, 20 wt % of a glass composition, 5 wt % of an acrylic resin (SPB 80), and a balance amount of dihydroterpineol (DHT) was applied and then, fired at 690° C. for 90 minutes under a reduction atmosphere with a wetter temperature of 35° C. to form an external electrode. Herein, the glass composition included 9.1 mol % of lithium oxide (Li₂O), 10 mol % of sodium oxide (Na₂O), 1.5 mol % of iron oxide (III) (Fe₂O₃), 6.3 mol % of zinc oxide (ZnO), 21 mol % of barium oxide (BaO), 11 mol % of silicon dioxide (SiO₂), 8 mol % of calcium oxide (CaO), 12 mol % of aluminum oxide (Al₂O₃), 20.2 mol % of boron trioxide (B₂O₃), and 1 mol % of tin oxide (IV) (SnO₂).

Next, a multilayer ceramic capacitor was manufactured through processes such as plating.

### Comparative Example 1

On a surface of the capacitor body on which the Cu particle film was formed, a paste including 70 wt % of Cu, 20 wt % of a glass composition, 5 wt % of an acrylic resin (SPB 80), and a balance amount of dihydroterpineol (DHT) was applied and then, fired at 690° C. for 90 minutes under a reduction atmosphere with a wetter temperature of 35° C. to form an external electrode.

Next, a multilayer ceramic capacitor was manufactured through processes such as plating.

### Evaluation 1: Sem Analysis

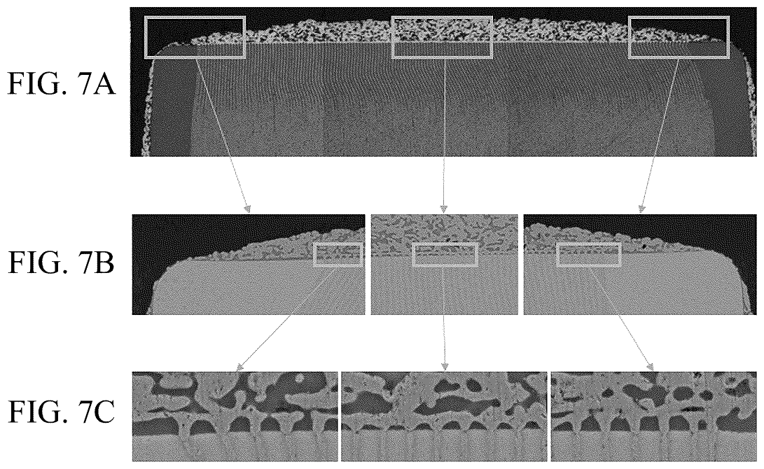

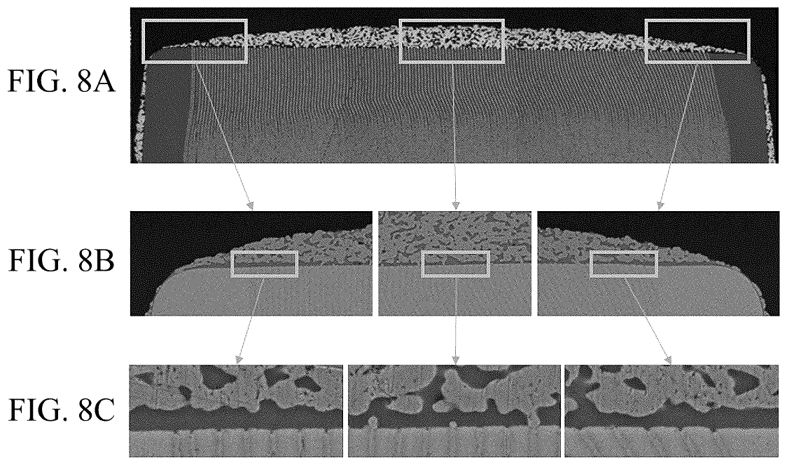

The multilayer ceramic capacitors manufactured in Example 1 and Comparative Example 1 were subjected to scanning electron microscope (SEM) analysis by the following method, and the results are shown in FIGS. 7A to 8C.

Each multilayer ceramic capacitor was loaded onto a tape with the L-axis and T-axis direction surfaces (LT surfaces) facing upward, placed in an epoxy mixing solution, and cured. Then, the LT surface of the capacitor body was polished to ½ of the point in the W-axis direction, thereby obtaining a cross-sectional sample having an LT surface so that the external electrode can be observed. Subsequently, one side of the obtained cross-sectional sample was measured by SEM to observe the capacitor body and external electrode. SEM was measured at an accelerating voltage of 20 kV and a magnification of 10k.

FIGS. 7A to 7C are scanning electron microscope (SEM) analysis images of the external electrode of the multilayer ceramic capacitor according to Example 1 and FIGS. 8A to 8C are scanning electron microscope (SEM) analysis images of the external electrode of the multilayer ceramic capacitor according to Comparative Example 1.

Referring to FIGS. 7A to 7C, the external electrode of Example 1 had an interface layer on a surface of an active region of the capacitor body, wherein the interface layer had a bridge structure including a body region, a plurality of leg regions connected to a lower portion of the body region, and a span region disposed between the plurality of leg regions. In addition, the leg regions in the interface layer were connected to the internal electrode layers, and the span region was disposed on a surface of the dielectric layer. Furthermore, when a junction region of the external electrode and the capacitor body was divided into three portions such as upper, center, and lower portions in a stacking direction, i.e., a thickness direction (T-axis direction) of the multilayer ceramic capacitor, the external electrodes all in the upper, central, and lower portions had an interface layer of the bridge structure. In addition, the number of internal electrode layers connected to the leg region of the interface layer had a ratio of 90% or more based on a total number of internal electrode layers in the active region.

On the other hand, referring to FIGS. 8A to 8C, in the external electrode of Comparative Example 1, the bridge structure was not formed, but glass was spread on the interface with the capacitor body.

Accordingly, as the external electrode manufactured in the MOD method according to an embodiment had an interface layer with the bridge structure on the interface with the active region of the capacitor body, securing excellent moisture resistance reliability by completely blocking an inflow of external moisture as well as excellent connectivity of the external electrode with the internal electrode layer.

### Evaluation 2: Sem-eds Analysis

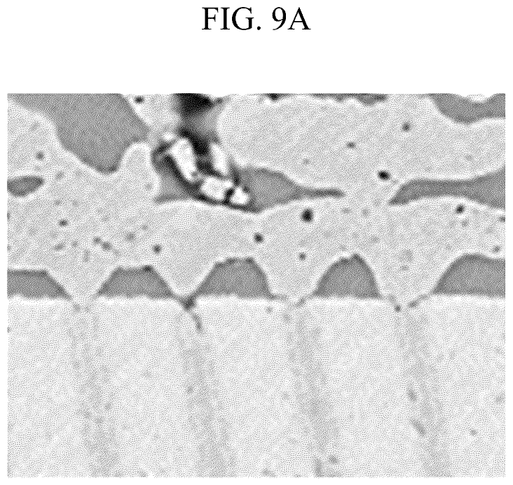

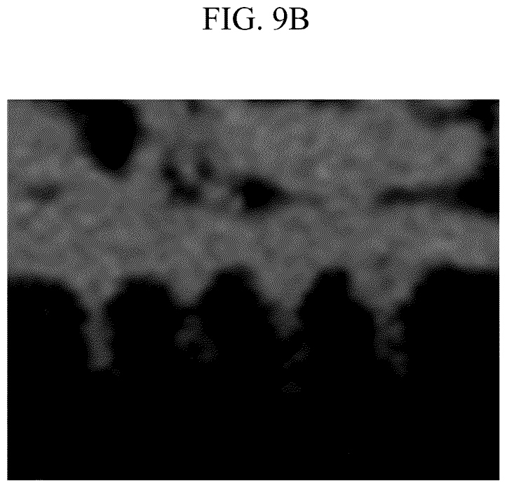

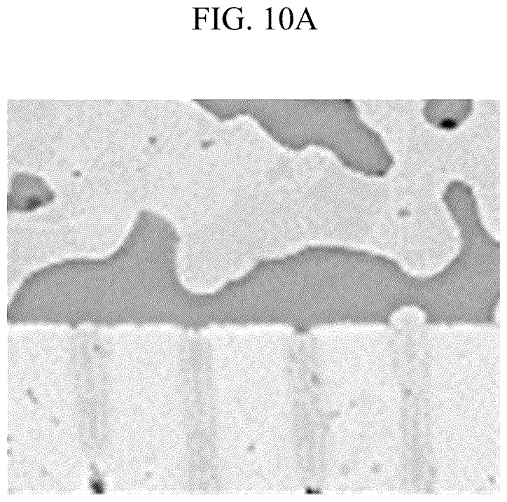

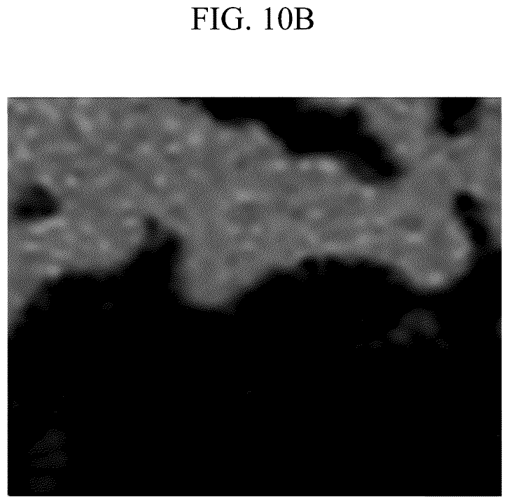

The multilayer ceramic capacitors according to Example 1 and Comparative Example 1 were subjected to scanning electron microscope-energy dispersive spectroscopy (SEM-EDS) analysis, and the results are shown in FIGS. 9A to 10B.

The SEM images of the cross-sectional samples obtained in Evaluation 1 were subjected to energy dispersive spectroscopy (EDS) analysis for mapping analysis of Cu.

FIGS. 9A and 9B are scanning electron microscope-energy dispersive spectroscopy (SEM-EDS) mapping analysis images of the external electrode of the multilayer ceramic capacitor according to Example 1, and FIGS. 10A and 10B are scanning electron microscope-energy dispersive spectroscopy (SEM-EDS) mapping analysis images of the external electrode of the multilayer ceramic capacitor according to Comparative Example 1.

Referring to FIGS. 9A and 9B, in Example 1, the interface layer had a bridge structure, and Cu was mostly distributed in the body region and the leg region of the interface layer. In addition, as copper was seen to be diffused even to the internal electrode layer as well as the leg region of the interface layer, it was confirmed that Cu formed a Cu-Ni alloy with Ni of the internal electrode layer, which existed in the leg region of the interface layer and the internal electrode layer.

On the other hand, Comparative Example 1 exhibited no bridge structure and no Cu on the interface between external electrode and internal electrode layer and thus deteriorated connectivity of external electrode and internal electrode layer.

Accordingly, the external electrode manufactured in the MOD method according to an embodiment exhibited excellent moisture resistance reliability by completely blocking an inflow of external moisture due to glass on a surface of the dielectric layer as well as excellent connectivity with the internal electrode layer.

### Evaluation 3: Capacitance Characteristics

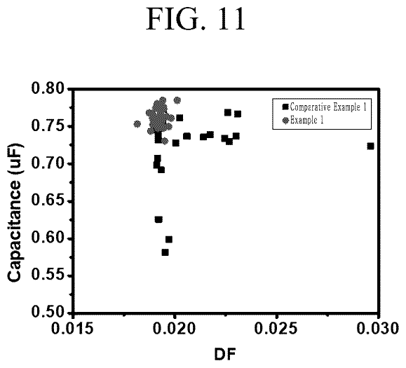

The multilayer ceramic capacitors according to Example 1 and Comparative Example 1 were measured with respect to capacitance and dielectric loss (DF) under conditions of 1000 Hz and 0.5 V, and the results are shown in FIG. 11.

FIG. 11 is a graph showing the capacitance characteristics of the multilayer ceramic capacitor according to Example 1 and Comparative Example 1.

Referring to FIG. 11, in the multilayer ceramic capacitor of Example 1 in which the interface layer with the bridge structure was formed on the interface between the active region of the capacitor body and the external electrode, compared with that of Comparative Example 1, capacitance dispersion was reduced due to deteriorated contact properties of external electrode and internal electrode layer, and dielectric loss (DF) dispersion was also reduced.

### Evaluation 4: Moisture Resistance Reliability

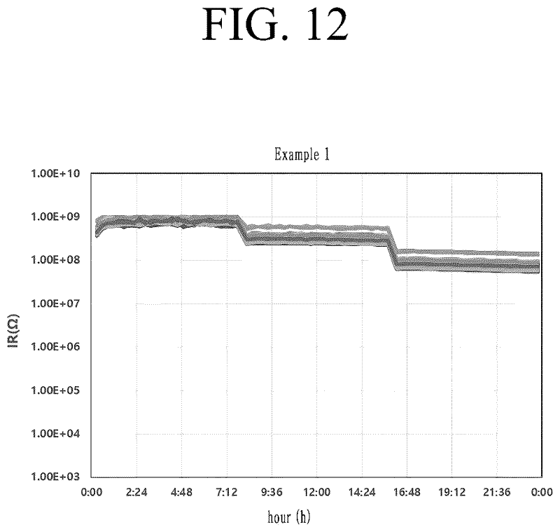

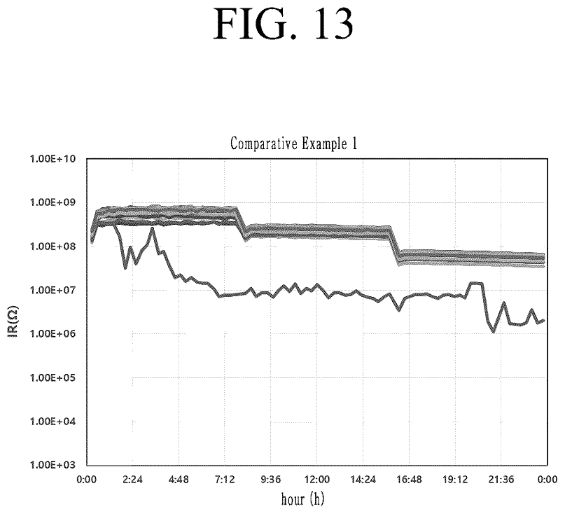

The multilayer ceramic capacitors according to Example 1 and Comparative Example 1 were evaluated with respect to humidity harshness, and the results are shown in FIGS. 12 and 13.

Specifically, the multilayer ceramic capacitors of Example 1 and Comparative Example 1 were respectively prepared by 20 and then, mounted on a measurement substrate to evaluate the humidity harshness by using ESPEC (PR-3J, 8585) equipment at 85° C. under relative humidity (R.H.) of 85%, for 24 hours.

FIG. 12 is a graph showing the moisture resistance reliability of the multilayer ceramic capacitor according to Example 1, and FIG. 13 is a graph showing the moisture resistance reliability of the multilayer ceramic capacitor according to Comparative Example 1.

Referring to FIGS. 12 and 13, the multilayer ceramic capacitor of Example 1, in which the interface layer with the bridge structure was formed on the interface between the active region of the capacitor body and the external electrode, compared with Comparative Example 1, exhibited excellent moisture resistance reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including:
a plurality of dielectric layers including a first dielectric layer and a second dielectric layer, and
a plurality of internal electrode layers stacked with the first dielectric layer interposed therebetween; and
an external electrode disposed on an outer surface of the capacitor body,
wherein the capacitor body includes:
an active region including the first dielectric layer and the internal electrode layers, and
a cover region including the second dielectric layer, the second dielectric layer being disposed on a first surface of the active region and a second surface of the active region, where the first surface opposes the second surface in a stacking direction,
the external electrode includes:
an interface layer disposed on a third surface of the active region, and
an external layer covering the interface layer,
the interface layer has a bridge structure including a body region, a leg region comprising a plurality of leg regions connected to a first portion of the body region, and a span region disposed between the plurality of leg regions,
the leg region of the interface layer is connected to the internal electrode layers,
the span region of the interface layer is disposed on a surface of the first dielectric layer, and
a ratio of a number of internal electrode layers connected to the leg region of the interface layer is greater than or equal to 90% and less than or equal to 100% based on a total number of internal electrode layers in the active region.

2. The multilayer ceramic capacitor of claim 1, wherein
the leg region of the interface layer extends into an interior of the capacitor body and is connected to the internal electrode layers.

3. The multilayer ceramic capacitor of claim 1, wherein
the leg region of the interface layer includes an alloy that includes a conductive metal.

4. The multilayer ceramic capacitor of claim 1, wherein
the leg region of the interface layer includes a Cu-Ni alloy.

5. The multilayer ceramic capacitor of claim 3, wherein
the leg region of the interface layer includes the alloy in an amount of 60 volume % to 100 volume % based on a total amount of the leg region.

6. The multilayer ceramic capacitor of claim 1, wherein
the span region of the interface layer includes glass.

7. The multilayer ceramic capacitor of claim 6, wherein
the glass includes at least one selected from aluminum oxide (Al₂O₃) and silicon dioxide (SiO₂).

8. The multilayer ceramic capacitor of claim 6, wherein
the span region of the interface layer includes the glass in an amount of 60 volume % to 100 volume % based on a total amount of the span region.

9. The multilayer ceramic capacitor of claim 1, wherein
the body region of the interface layer includes a conductive metal.

10. The multilayer ceramic capacitor of claim 1, wherein
the body region of the interface layer includes copper (Cu).

11. The multilayer ceramic capacitor of claim 9, wherein
the body region of the interface layer includes the conductive metal in an amount of 60 volume % to 100 volume % based on a total amount of the body region.

12. The multilayer ceramic capacitor of claim 1, wherein
the leg region of the interface layer includes an alloy that includes a conductive metal,
the span region of the interface layer includes glass, and
the body region of the interface layer includes the conductive metal.

13. The multilayer ceramic capacitor of claim 1, wherein
the leg region of the interface layer includes a Cu-Ni alloy,
the span region of the interface layer includes glass, and
the body region of the interface layer includes copper (Cu).

14. The multilayer ceramic capacitor of claim 1, wherein
the internal electrode layers include an alloy at an interface with the interface layer, and
the alloy includes a conductive metal.

15. A multilayer ceramic capacitor, comprising
a capacitor body including:
a plurality of dielectric layers including a first dielectric layer and a second dielectric layer, and
a plurality of internal electrode layers stacked with the first dielectric layer interposed therebetween; and
an external electrode disposed on an outer surface of the capacitor body,
wherein the capacitor body includes:
an active region including the first dielectric layer and the internal electrode layers, and
a cover region including the second dielectric layer, the second dielectric layer being disposed on a first surface of the active region and a second surface of the active region, where the first surface opposes the second surface in a stacking direction,
the external electrode includes:
an interface layer disposed on a third surface of the active region, and
an external layer covering the interface layer,
the interface layer has a bridge structure including a body region, a leg region comprising a plurality of leg regions connected to a first portion of the body region, and a span region disposed between the plurality of leg regions,
the leg region of the interface layer is connected to the internal electrode layers,
the span region of the interface layer is disposed on a surface of the first dielectric layer,
the body region of the interface layer includes a conductive metal,
the leg region of the interface layer includes an alloy that includes the conductive metal, and
the span region of the interface layer includes glass.

16. The multilayer ceramic capacitor of claim 15, wherein
the conductive metal includes copper (Cu),
the alloy includes a Cu-Ni alloy, and
the glass includes aluminum oxide (Al₂O₃) and silicon dioxide (SiO₂).

17. A method of manufacturing a multilayer ceramic capacitor, comprising
forming an external electrode on a surface of a capacitor body that includes a plurality of dielectric layers including a first dielectric layer, and a plurality of internal electrode layers stacked with the first dielectric layer interposed therebetween, wherein the external electrode includes an interface layer, and an external layer covering the interface layer,
the forming of the external electrode including:
applying a metal-organic decomposition (MOD) ink to the surface of the capacitor body,
reducing the applied metal-organic decomposition (MOD) ink to form a metal particle film;
applying a paste including a conductive metal and a glass composition on the metal particle film; and
firing the metal particle film and the applied paste to form the interface layer and the external layer, respectively,
wherein the interface layer has a bridge structure including a body region, a leg region comprising a plurality of leg regions connected to a first portion of the body region, and a span region disposed between the plurality of leg regions,
the leg region of the interface layer is connected to the internal electrode layers, and
the span region of the interface layer is disposed on a surface of the first dielectric layer.

18. The method of claim 17, wherein
the metal-organic decomposition (MOD) ink includes a metal ligand material, an amine compound, a binder, an antioxidant, and a solvent.

19. The method of claim 17, wherein
the metal particle film includes metal nanoparticles having a size of 10 nm to 100 nm.

20. The method of claim 17, wherein
the paste includes the glass composition in an amount of 20 wt % to 40 wt % based on a total amount of the paste.

21. A method of manufacturing a multilayer ceramic capacitor, comprising
forming an external electrode on a surface of a capacitor body that includes a plurality of dielectric layers including a first dielectric layer, and a plurality of internal electrode layers stacked with the first dielectric layer interposed therebetween, wherein the external electrode includes an interface layer, and an external layer covering the interface layer,
the forming of the external electrode including:
applying a metal ligand material to the surface of the capacitor body;
reducing the applied metal ligand material to form a film that includes metal particles;
applying a paste including a conductive metal and a glass composition on the film; and
firing the film and the applied paste to form the interface layer and the external layer, respectively,
wherein the interface layer includes glass.

22. The method of claim 21, wherein
the interface layer has a bridge structure including a body region, a leg region comprising a plurality of leg regions connected to a first portion of the body region, and a span region disposed between the plurality of leg regions,
the leg region of the interface layer extends from the internal electrode layers to the first portion of the body region, and
the span region of the interface layer is disposed on a surface of the first dielectric layer.

23. The method of claim 22, wherein
the reducing of the applied metal ligand material is carried out in a nitrogen atmosphere at a temperature of 170° C. to 300° C. for 30 minutes to 3 hours.

24. The method of claim 17, wherein
the metal ligand material includes copper formate.
